(19) United States
(12) Patent Application Publication
(10) Pub. No.: US 2014/0288677 A1
(43) Pub. Date: Sep. 25, 2014

(54) CONTROL DEVICE AND METHOD FOR ELECTRONIC APPARATUS, ELECTRONIC APPARATUS, AND NON-TRANSITORY COMPUTER READABLE MEDIUM

(71) Applicant: FUJI XEROX CO., LTD., Tokyo (JP)

(72) Inventor: Koichi SATO, Kanagawa (JP)

(73) Assignee: FUJI XEROX CO., LTD., Tokyo (JP)

(21) Appl. No.: 14/012,570

(22) Filed: Aug. 28, 2013

(30) Foreign Application Priority Data
Mar. 21, 2013 (JP) 2013-058271

(51) Int. Cl. G05B 15/02

(52) U.S. Cl. CPC G05B 15/02
USPC 700/83

(57) ABSTRACT

A control device is used for an electronic apparatus. A memory stores linkup information and image data unique to the linkup information in association with each other. The linkup information indicates plural functions of the electronic apparatus, its linking order, and parameter values for the functions. A receiver displays an image of the image data. An extracting unit extracts, when an operation for integrating plural items of the linkup information has been received, a common function included in all the items of linkup information. A setting unit sets a parameter value of the common function if the parameter value of the common function differs according to the item of linkup information. Linkup-information integrating information which indicates an integrating order of the common function and non-common functions other than the common function, the parameter value of the common function, and parameter values of the non-common functions is stored in the memory.

### CROSS-REFERENCE TO RELATED APPLICATIONS

This application is based on and claims priority under 35 USC 119 from Japanese Patent Application No. 2013-058271 filed Mar. 21, 2013.

### BACKGROUND

1. Technical Field

The present invention relates to a control device and method for an electronic apparatus, an electronic apparatus, and a non-transitory computer readable medium.

2. Summary

According to an aspect of the invention, there is provided a control device for an electronic apparatus, including: a memory that stores therein linkup information and image data which indicates an operator unique to the linkup information in association with each other, the linkup information indicating plural functions of the electronic apparatus, a linking order of the plural functions, and parameter values which are individually set for the plural functions and are used when processing is executed by using the plural functions in the linking order; a receiver that displays an image corresponding to the image data indicating the operator stored in the memory and also receives an operation performed on the operator; an extracting unit that extracts, when an integrating operation for integrating plural items of the linkup information has been received by the receiver, a common function included in all the plural items of linkup information; and a setting unit that sets a parameter value of the common function in accordance with predetermined rules if a parameter value of the common function of one of the plural items of linkup information extracted by the extracting unit is different from a parameter value of the common function of another one of the plural items of linkup information. The memory stores therein linkup-information integrating information which indicates an integrating order of the common function and non-common functions, the parameter value of the common function set by the setting unit, and parameter values of the non-common functions, the non-common functions being included in the plural items of linkup information to be integrated by the integrating operation and being other than the common function.

### BRIEF DESCRIPTION OF THE DRAWINGS

Exemplary embodiments of the present invention will be described in detail based on the following figures, wherein:

FIG. 1 illustrates an example of the hardware configuration of an image forming apparatus;

FIG. 2 is an external view of an operation unit;

FIG. 3 illustrates an example of the functional configuration of the image forming apparatus;

FIG. 4 illustrates an operation screen;

FIGS. 5A through 5E illustrate items of linkup information;

FIG. 6 illustrates the order of priority set for parameter values;

FIG. 7 is a flowchart illustrating an operation of a first exemplary embodiment;

FIGS. 8A through 8D illustrate linkup-information integrating information;

FIG. 9 illustrates an icon associated with linkup-information integrating information;

FIG. 10 illustrates linkup-information integrating information;

FIG. 11 illustrates linkup-information integrating information;

FIG. 12 illustrates linkup-information integrating information;

FIG. 13 illustrates the order of priority set for parameter values; and

FIG. 14 illustrates linkup-information integrating information.

### DETAILED DESCRIPTION

### First Embodiment

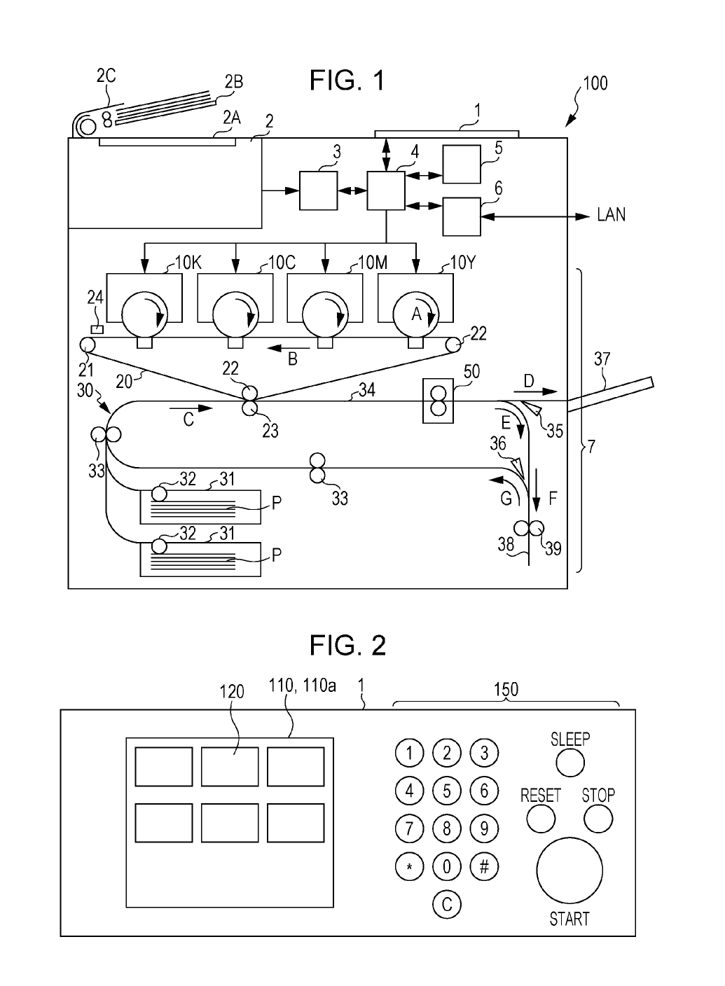

FIG. 1 illustrates an example of the hardware configuration of an image forming apparatus 100.

The image forming apparatus 100 is an example of an electronic apparatus according to an exemplary embodiment of the invention.

A controller 4 includes a central processing unit (CPU), which is an example of an arithmetic unit, a read only memory (ROM), and a random access memory (RAM) (none of which are shown). The ROM and the RAM are examples of storage devices. In the ROM, firmware which describes a procedure for starting hardware and an operating system (OS) is stored. In the RAM, data used for the CPU to execute operations is stored.

A storage device 5 is, for example, a hard disk storage device. An OS, application programs, etc. are stored in the storage device 5. The controller 4 executes the OS or an application program stored in the storage device 5 so as to control individual elements of the image forming apparatus 100.

A communication unit 6 is a communication interface (I/F), and is connected to, for example, a local area network (LAN) (not shown), so as to establish communication between the image forming apparatus 100 and another apparatus.

A reader 2 optically reads a document and generates image data from the read document. More specifically, the reader 2 includes a light source, an optical system, an imaging device, and an analog-to-digital conversion circuit (none of which are shown). A document placed on platen glass 2A is irradiated with light by the light source. Then, light reflected by the document is separated into red (R), green (G), and blue (B) light components through the optical system, and the light components are incident on the imaging device. Then, the imaging device converts the incident light components into an electric signal, and supplies it to an image processor 3. The reader 2 also includes a document table 2B on which documents are placed and a document transport mechanism 2C which transports documents placed on the document table 2B to the platen glass 2A one by one.

The image processor 3 performs image processing on image data. More specifically, the image processor 3 performs analog-to-digital conversion on an electric signal supplied from the reader 2, and then performs noise reduction, gamma correction, conversion from R, G, and B colors into yellow (Y), magenta (M), cyan (C), and black (K), screen processing, etc. The image reader 3 also performs similar image processing on image data received from an external source by the communication unit 6. Then, image data indicating the tone of each color and each pixel is generated.

On the basis of the image data supplied from the image processor 3, image forming units 10Y, 10M, 10C, and 10K superpose Y, M, C, and K toner images on the surface of a recording medium P by using an electrophotographic system, thereby forming a full-color image. Since the image forming units 10Y, 10M, 10C, and 10K have the same configuration, they will be collectively referred to as an “image forming unit 10” unless it is necessary to distinguish them from each other. In this case, the indication of Y, M, C, and K is also omitted for the components forming the image forming unit 10.

A transport unit 30 transports a recording medium P along a transport path 34. More specifically, in medium storage units 31, sheet-like recording media P, such as paper, are stacked and stored, and feeder rollers 32 are rotated together with an operation of the image forming unit 10, thereby feeding recording media P to the transport path 34 one by one. Transport rollers 33 disposed on the transport path 34 are rotated, thereby transporting a recording medium P along the transport path 34 in the direction indicated by the arrow C. In the following description, the recording medium P is called a sheet.

FIG. 2 is an external view of an operation unit 1. The operation unit 1 includes a touch panel 110 and a keypad 150.

The touch panel 110 is a display device using a liquid crystal or organic electroluminescence (EL) elements. The touch panel 110 has a rectangular and planar display area 110a, and icons 120 are displayed in the display area 110a. The icons 120 are virtual operators associated with individual functions of the image forming apparatus 100. The touch panel 110 detects an operation performed on the display area 110a by a user, and the controller 4 operates the image forming apparatus 100 in accordance with the detected operation. The type of touch panel 100 is not particularly restricted, and may be, for example, an electrostatic-capacitance type or an electromagnetic-induction type. In this exemplary embodiment, a user performs an operation by touching the display area 110a with a finger, that is, the touch panel 110 of electrostatic-capacitance type is used.

The keypad 150 includes a set of push-button keys, for example, keys for inputting decimal numerals from 0 to 9 and symbols (*, #), a clear key for canceling input numeric values or symbols, a reset key for canceling settings set by the keypad 150, a start key for starting an operation, a stop key for stopping an operation, and a sleep key for switching the state of the image forming apparatus 100 to a power-saving state.

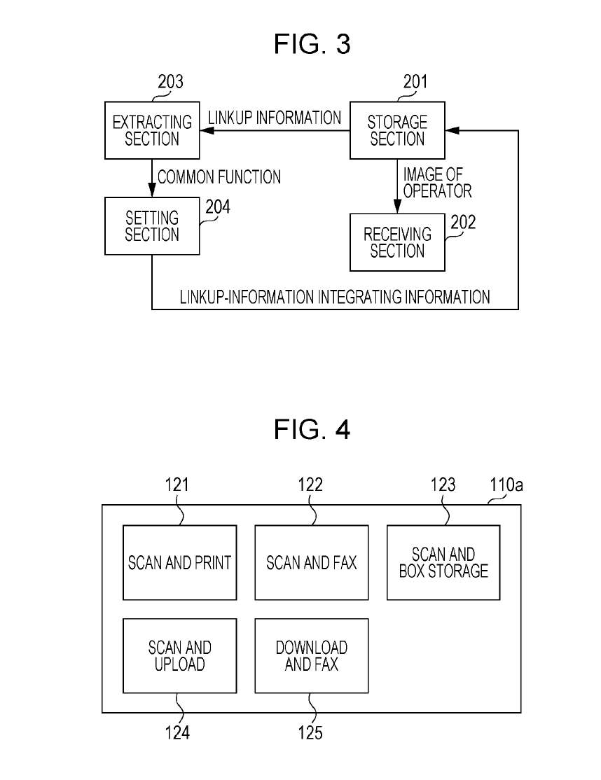

FIG. 3 illustrates an example of the functional configuration of the image forming apparatus 100. This functional configuration is an example of the functional configuration of a control device of an exemplary embodiment of the invention, and the controller 4 controls the hardware of the image forming apparatus 100 in accordance with a program stored in the storage device 5, thereby implementing functions shown in FIG. 3. Examples of the functions are a storage section 201, a receiving section 202, an extracting section 203, and a setting section 204, as shown in FIG. 3.

The storage section 201 will first be discussed.

The storage section 201 stores therein linkup information and image data of the icons 120 unique to the linkup information in association with each other. The linkup information indicates plural functions of the image forming apparatus 100, the linking order of plural functions, and parameters which are set for the individual functions and are used when operations are executed by using the plural functions in this linking order. This will be described below more specifically.

FIG. 4 illustrates an operation screen. In the storage device 5, image data for displaying a screen in which the icons 120 are disposed in the display area 110a is stored, and when the image forming apparatus 100 is powered ON, the screen shown in FIG. 4 is displayed. In FIG. 4, icons 121 through 125 are displayed as examples of the icons 120. On the individual icons 121 through 125, the names of functions associated with the icons 121 through 125 are indicated.

The icon 121 is associated with a scan and print function. The scan and print function is a function of optically reading a document and generating image data by using the reader 2 (scan function) and of forming an image on a sheet on the basis of this image data by using the image forming unit 10 (print function). A series of these functions may also be called a copy function. For the sake of description, however, in the specification and the drawing of this exemplary embodiment, this function will be referred to as a scan and print function in the sense that a scan function and a print function are integrated.

The icon 122 is associated with a scan and fax function. The scan and fax function is a function of optically reading a document and generating image data by using the reader 2 (scan function) and of sending this image data to another image forming apparatus via telephone lines by the communication unit 6 (fax function). A series of these functions may also be called a fax function. For the sake of description, however, in the specification and the drawing of this exemplary embodiment, a function concerning only sending of image data is referred to as a fax function, and the above-described function will be referred to as a scan and fax function in the sense that a scan function and a fax function are integrated.

The icon 123 is associated with a scan and box-storage function. The scan and box-storage function is a function of optically reading a document and generating image data by using the reader 2 (scan function) and of storing this image data in the storage device 5 (box-storage function). When a user touches the icon 123, a screen for inputting a box number and a password is displayed. When the user inputs a box number and a password assigned to the user, image data is generated by the scan function and the generated image data is stored in the storage device 5 in association with the box number. By accessing this box number by using a computer connected to the image forming apparatus 100 via a LAN, the image data is transferred to the computer.

The icon 124 is associated with a scan and upload function. The scan and upload function is a function of optically reading a document and generating image data by using the reader 2 (scan function) and of transferring this image data to a server (upload function). When a user touches the icon 124, a screen for specifying an upload destination is displayed. When the user specifies an upload destination, image data is generated by using the scan function and is transferred to the upload destination.

The icon 125 is associated with a download and fax function. The download and fax function is a function of sending image data obtained (downloaded) from a server to another fax machine (fax function). When a user touches the icon 125, a screen for specifying image data to be downloaded is displayed. When the user specifies image data to be downloaded, a screen for specifying a destination to which the image data will be sent by using the fax function is displayed. When the user specifies a destination, the image data is sent to this destination.

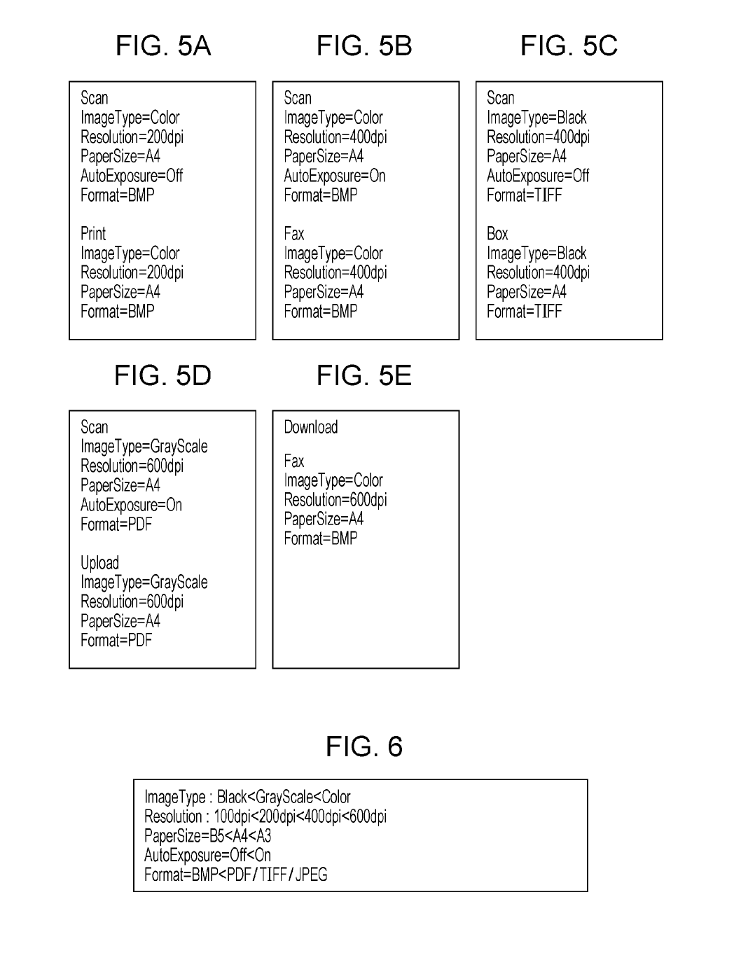

FIGS. 5A through 5E illustrate items of linkup information.

FIG. 5A illustrates linkup information concerning the scan and print function. This linkup information and image data indicating the icon 121 are stored in the storage device 5 in association with each other. The first row of the linkup information shown in FIG. 5A indicates the name of a function to be executed first. Scan indicates a scan function. The second through the sixth row immediately above a blank line indicate parameters of the scan function. Each parameter is expressed by associating a parameter name with a parameter value by using an equal sign.

ImageType is a parameter name indicating the color range expressed by image data, and as the parameter value, one of Black (black and white), GrayScale (grayscale), and Color (full color) is selected. In this example, Color is set.

Resolution is a parameter name indicating the resolution of image data, and as the parameter value, one of 100 dpi (dot per inch), 200 dpi, 400 dpi, and 600 dpi is selected. In this example, 200 dpi is selected.

PaperSize is a parameter name indicating the size of a sheet, and as the parameter value, one of B5, A4, and A3 standardized by Japanese Industrial Standards is selected. In this example, A4 is selected.

AutoExposure is a parameter name indicating whether a function of adjusting the exposure when a document is read by an image forming apparatus is used. As the parameter value, Off (not used) or On (used) is selected. In this example, Off is set.

Format is a parameter name indicating the format of image data. The format of image data to be generated in the scan function is determined while being dependent on the function to be executed subsequent to the scan function. In this example, the print function is executed subsequent to the scan function. In the print function, an image is formed on the basis of bitmap (BMP) image data, and thus, BMP image data is also generated in the scan function. Accordingly, BMP is set as the parameter value of Format of the scan function.

The row subsequent to the blank line indicates the name of a function to be executed subsequent to the first function. Print indicates a print function. In this manner, if plural function names are described in linkup information, the order of these functions to be linked is represented by the order of function names described in the linkup information.

In the print function, the same parameter values as those of the scan function are set, except for AutoExposure. In the print function, if image data having a format other than BMP, for example, PDF (Portable Document Format), TIFF (Tagged Image File Format), or JPEG (Joint Photographic Experts Group), is supplied, the image processor 3 converts this image data into BMP image data and then outputs it to the image forming unit 10.

FIG. 5B illustrates linkup information concerning the scan and fax function. Fax is a function name indicating a fax function. As in the case of the scan and print function, BMP is set as the parameter value of Format. This linkup information and image data indicating the icon 122 are stored in the storage device 5 in association with each other.

FIG. 5C illustrates linkup information concerning the scan and box-storage function. Box is a function name indicating a box-storage function. In the scan and box-storage function, a user selects one of predetermined plural formats, and the image processor 3 generates image data with the selected format. In this exemplary embodiment, one of BMP, PDF, TIFF, and JPEG formats is selected. In this example, TIFF is selected. This linkup information and image data indicating the icon 123 are stored in the storage device 5 in association with each other.

FIG. 5D illustrates linkup information concerning the scan and upload function. Upload is a function name indicating an upload function. As the parameter value of Format, PDF is set. Since this format has been specified by an upload destination, it is not possible to change by the image forming apparatus 100. This linkup information and image data indicating the icon 124 are stored in the storage device 5 in association with each other.

FIG. 5E illustrates linkup information concerning the download and fax function. Download is a function name indicating a download function. Parameters are not set for the download function. The reason for this is as follows. Parameter values of image data to be downloaded may be different from parameter values set for the fax function, in which case, the image processor 3 converts downloaded image data so that the parameter values of the downloaded image data will coincide with those set for the fax function. This linkup information and image data indicating the icon 125 are stored in the storage device 5 in association with each other.

In the example shown in FIG. 5E, ImageType of Fax is Color. Thus, regardless of whether the color type of downloaded image data is full color, grayscale, or black and white, loss of color information will not occur when the image data is faxed. Accordingly, the image processor 3 does not convert the color of the image data. In contrast, if the parameter values of the resolution, paper size, and format of the downloaded image data are different from the parameter values set for Fax, the image processor 3 converts the image data so that the parameter values of the downloaded image data will coincide with those set for Fax.

The receiving section 202 will now be discussed below.

The receiving section 202 displays images corresponding to image data of the icons 120 stored in the storage section 201 and also receives operations performed on the icons 120. The receiving section 202 is the above-described touch panel 110. Major operations performed on the icons 120 are tap, drag, and drop operations. While a user is holding a finger on the display area 110a, the touch panel 110 regularly outputs contact position information indicating a position at which the finger is in contact with the display area 110a to the controller 4. The controller 4 then determines what type of operation the user is performing on the basis of the received contact position information.

A tap operation is an operation for tapping the icon 120 with a finger. More specifically, if the length of time for which a finger continuously touches the icon 120 is equal to or smaller than a predetermined threshold, this operation is considered as a tap operation.

When executing processing by using a function associated with one of the icons 120, a user taps the icon 120 associated with this function. Then, a screen for specifying parameters for this function is displayed. On this screen, parameter values which have been set in the linkup information are displayed as initial values. If the user desires to change these initial values, the user operates the touch panel 110 or the keypad 150 to change the initial values. When the user presses the start key, processing is started in accordance with the linkup information.

A drag operation is an operation for moving a finger on the display area 110a while holding the finger on the icon 120. More specifically, if the length of time for which a finger continuously touches the icon 120 exceeds the predetermined threshold, the controller 4 moves the icon 120 on the display area 110a on the basis of contact position information. The contact position information is regularly output to the controller 4. Accordingly, every time the controller 4 receives the contact position information, it calculates an amount by which a finger has been displaced from a contact position obtained when the previous contact position information has been received, and moves the icon 120 on the display area 110a by the calculated displacement amount.

A drop operation is an operation for releasing a finger from the icon 120 which has been moved by performing a drag operation.

The extracting section 203 will now be discussed below.

An integrating operation for integrating plural items of linkup information may be received by the receiving section 202. In this case, the extracting section 203 extracts a common function included in all the plural items of linkup information to be integrated. The integrating operation is, for example, a drag-and-drop operation performed on the icons 120. That is, a user moves a finger while holding it on one of the icons 120 so as to move and superpose the icon 120 on another icon 120, and then releases the finger. When this operation is received by the receiving section 202, the controller 4 determines that an integrating operation for integrating plural items of linkup information has been performed.

When an integrating operation has been performed, the controller 4 extracts a common function included in all the plural items of linkup information to be integrated. A common function is, for example, the same function included in an item of linkup information associated with a dragged icon and in an item of linkup information associated with an icon in which the dragged icon has been dropped. For example, if the icon 121 (scan and print function) is dragged and dropped in the icon 122 (scan and fax function), the common function is a scan function. Functions other than the common function included in these two items of linkup information will be referred to as “non-common functions”. In this example, the print function and the fax function are non-common functions.

The setting section 204 will now be discussed below.

If the parameter values of a common function extracted by the extracting section 203 included in one item of linkup information are different from those of another item of linkup information, the setting section 204 sets parameter values of the common function in accordance with predetermined rules. For example, the setting section 204 preferentially selects, as a parameter value of the common function, a parameter value, by the use of which a larger storage area is necessary to execute processing. That is, if processing is executed by using the selected parameter value, a larger storage area is necessary to execute the processing.

FIG. 6 illustrates the order of priority set for parameter values. An inequality sign indicates which parameter value has a higher priority. For example, concerning Resolution, the priority becomes higher in ascending order of 100 dpi, 200 dpi, 400 dpi, and 600 dpi. For example, if the icon 121 (scan and print function) is dragged and dropped into the icon 122 (scan and fax function), the common function is a scan function. Resolution of the scan function associated with the icon 121 is 200 dpi, while Resolution of the scan function associated with the icon 122 is 400 dpi. In this case, since 400 dpi has a higher priority than 200 dpi, 400 dpi is set as Resolution of the common scan function. Concerning ImageType, the priority becomes higher in ascending order of Black, GrayScale, and Color. Concerning PaperSize, the priority becomes higher in ascending order of B5, A4, and A3. Concerning AutoExposure, On has a higher priority than Off. Concerning Format, BMP has the lowest priority, and PDF, TIFF, and JPEG have the same priority.

After the setting function 204 has set parameter values of a common function, the storage section 205 stores therein linkup-information integrating information. The linkup-information integrating information indicates the linking order of the common function and non-common functions included in plural items of linkup information to be integrated by an integrating operation, parameter values set by the setting section 204, and parameter values of the non-common functions. The process for generating linkup-information integrating information will be discussed later.

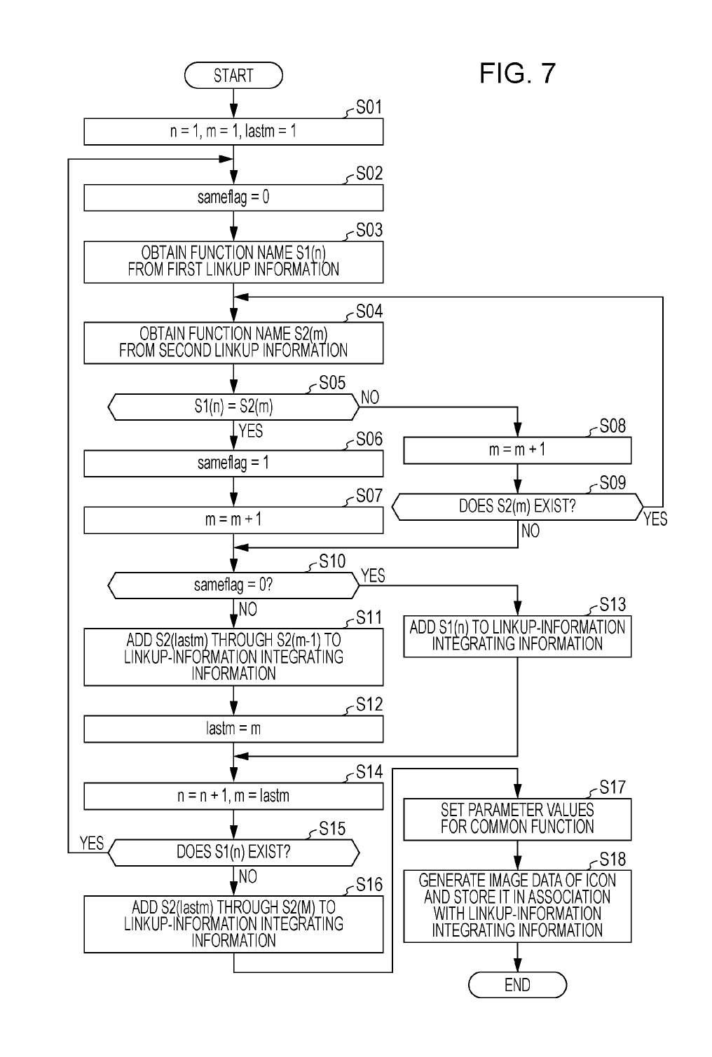

FIG. 7 is a flowchart illustrating an operation of the first exemplary embodiment. This operation is executed when an integrating operation is received by the receiving section 202.

In this exemplary embodiment, an example in which the scan and upload function is integrated with the scan and print function by dragging and dropping the icon 124 into the icon 121 will be discussed. Linkup information associated with an icon to be dragged will be referred to as “first linkup information, and linkup information associated with an icon in which a dragged icon is dropped will be referred to as “second linkup information. In this example, the linkup information associated with the scan and upload function shown in FIG. 5D is first linkup information, and the linkup information associated with the scan and print function shown in FIG. 5A is second linkup information.

In step S01, the controller 4 initializes counters n, m, and lastm to 1. The counter n is a counter that counts the number of functions included in the first linkup information. The counter m is a counter that counts the number of functions included in the second linkup information. The counter lastm is a counter value corresponding to a function name obtained from the second linkup information.

In step S02, the controller 4 initializes a flag sameflag to 0. The flag sameflag indicates whether a common function is included in the first linkup information and the second linkup information. If a common function is included, the flag sameflag is set to be 1.

In step S03, the controller 4 obtains a function name S1(n) from the first linkup information. When a predetermined character string, such as Scan, Print, Fax, Box, Upload, or Download is read from the first linkup information, the controller 4 obtains this character string as a function name. In this example, Scan is obtained as a function name S1(1).

In step S04, the controller 4 obtains a function name S2(m) from the second linkup information. In this example, Scan is obtained as a function name S2(1).

In step S05, the controller 4 determines whether S1(n) is equal to S2(m). If S1(n) is equal to S2(m) (if the result of step S05 is YES), the controller 4 proceeds to step S06. If S1(n) is not equal to S2(m) (if the result of step S05 is NO), the controller 4 proceeds to step S08. In this example, since S1(1) and S2(1) are equal to each other, the controller 4 proceeds to step S06.

In step S06, the controller 4 sets the flag sameflag to be 1. That is, S1(1) and S2(1) are a common function. The controller 4 stores Scan as the function name of the common function.

In step S07, the controller 4 adds one to the counter m. As a result, in this example, m is set to be 2.

In step S10, the controller 4 determines whether sameflag is 0. If sameflag is 0 (if the result of step S10 is YES), the controller 4 proceeds to step S13. If sameflag is not 0 (if the result of step S10 is NO), the controller 4 proceeds to step S11. In this case, since sameflag is 1 (the result of step S10 is NO), the controller 4 proceeds to step S11.

In step S11, the controller 4 writes S2(lastm) through S2(m−1) into the linkup-information integrating information. In this example, since lastm is 1 and m is 2, the controller 4 writes S2(1)=Scan into the linkup-information integrating information.

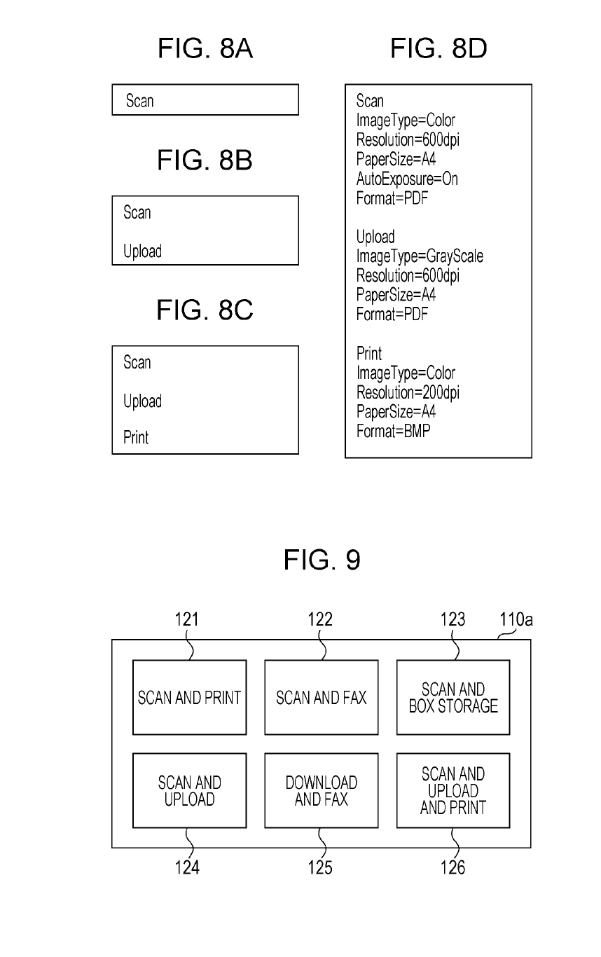

FIGS. 8A through 8D illustrate linkup-information integrating information. In this example, Scan is written into the first row of the linkup-information integrating information, as shown in FIG. 8A.

In step S12, the controller 4 substitutes the value m into lastm. As a result, in this example, lastm is set to be 2.

In step S14, the controller 4 adds one to the counter n, and substitutes the value of the counter lastm into the counter m. As a result, in this example, n is set to be 2, and m is set to be 2.

In step S15, the controller 4 determines whether S1(n) exists. If S1(n) exists (if the result of step S15 is YES), the controller returns to step S02. If S1(n) does not exist (if the result of step S15 is NO), the controller proceeds to step S16. In this example, since the function name Upload exists subsequent to Scan, the controller 4 returns to step S02.

In step S02, sameflag is set to be 0.

In step S03, S1(2)=Upload is obtained.

In step S04, S2(2)=Print is obtained.

Since it is found in step S05 that S1(2)=Upload is not equal to S2(2)=Print (the result of step S05 is NO), the controller 4 proceeds to step S08.

In step S08, the controller 4 adds one to the counter m. As a result, in this example, m is set to be 3.

In step S09, the controller 4 determines whether S2(m) exists. If S2(m) exists (if the result of step S09 is YES), the controller returns to step S04. If S2(m) does not exist (if the result of step S09 is NO), the controller proceeds to step S10. In this example, since a function name does not exist subsequent to Print, it is determined in step S09 that S2(3) does not exist, and the controller 4 proceeds to step S10.

Since it is found in step S10 that sameflag is 0 (the result of step S10 is YES), the controller 4 proceeds to step S13.

In step S13, the controller 4 adds S1(n) to the linkup-information integrating information. In this example, since n is 2, Upload is added, as shown in FIG. 8B.

In step S14, n is set to be 3, and m is set to be 2.

Since it is found in step S15 that S1(3) does not exist (the result of step S15 is NO), the controller proceeds to step S16.

In step S16, the controller 4 adds S2(lastm) through S2(M) to the linkup-information integrating information. M indicates the maximum value of m. In this example, since lastm is 2 and M is 2, Print is added, as shown in FIG. 8C.

In step S17, the controller 4 sets parameter values for the common function. More specifically, the controller 4 obtains parameter names of the function name Scan stored in step S06 from the first linkup information and the second linkup information. When predetermined character strings, such as ImageType, Resolution, PaperSize, AutoExposure, and Format, are read from the second row subsequent to the first row Scan until the first blank line, the controller 4 obtains these character strings as the parameter names. Then, the controller 4 compares a parameter value of each parameter name of the first linkup information with that of the second linkup information, and selects a parameter value of each parameter name having a higher priority. The controller 4 then adds the selected parameter values to the rows subsequent to the first row Scan of the linkup-information integrating information. In this example, the parameter value of ImageType of the first linkup information is GrayScale, and that of the second linkup information is Color. Since Color has a higher priority than GrayScale (see FIG. 6), Color is selected as the parameter value of ImageType of Scan of the linkup-information integrating information. Similarly, 600 dpi is selected as the parameter value of Resolution, A4 is selected as the parameter value of PaperSize, On is selected as the parameter value of AutoExposure, and PDF is selected as the parameter value of Format.

The controller 4 adds the selected parameter values to the linkup-information integrating information, as shown in FIG. 8D. The controller 4 also adds parameter values of non-common functions included in the first linkup information and the second linkup information which have not been integrated with each other to the linkup-information integrating information.

In step S18, the controller 4 generates image data indicating an icon unique to the generated linkup-information integrating information, and stores the generated image data in the storage device 5 in association with the linkup-information integrating information.

FIG. 9 illustrates an icon associated with linkup-information integrating information. In this example, an icon 126 associated with a scan-and-upload-and-print function is displayed. When a user places a document on a document table and taps the icon 126, a screen for inputting or selecting an upload destination is displayed. When the user inputs or selects an upload destination and presses the start key of the keypad 150, processing is started in accordance with the linkup-information integrating information shown in FIG. 8D.

More specifically, a document is first read by the reader 2 by using the scan function, and image data based on the parameter values, such as ImageType=Color, Resolution=600 dpi, PaperSize=A4, AutoExposure=On, and Format=PDF, is generated. Then, by using the upload function, a copy of the image data is generated, and ImageType of the copied image data is converted from Color to GrayScale, and then, the converted image data is uploaded to a destination server. Then, by using the print function, Resolution of the original image data is converted from 600 dpi to 200 dpi, and Format of the original image data is converted from PDF to BMP, and then, an image is formed on a sheet on the basis of the converted image data.

In this exemplary embodiment, if parameter values of a common function of one item of linkup information are different from those of another item of the linkup information, parameter values of the common function are set on the basis of a predetermined order of priority set for plural parameter values. Then, linkup-information integrating information indicating the linking order of the common function and non-common functions and the parameter values of the common function and those of the non-common functions is stored. If plural items of linkup information are simply integrated, processing to be executed by using a common function is executed more than once. In this exemplary embodiment, since the common function is written into linkup-information integrating information only once, processing to be executed by this common function is not executed more than once. Additionally, the order of priority has been determined so that a higher priority is set for a parameter value, by the use of which a larger storage area is necessary to execute processing. Accordingly, loss of image information does not occur.

### Second Exemplary Embodiment

In a second exemplary embodiment, portions different from those of the first exemplary embodiment will be described below.

In the second exemplary embodiment, if a parameter value of a common function is determined while being dependent on one of parameter values of a non-common function and if such a parameter value of the non-common function is not allowed to be changed, the setting section 204 sets the parameter value of the non-common function as a parameter value of the common function.

In the second exemplary embodiment, an example in which the scan and upload function is integrated with the scan and box-storage function by dragging and dropping the icon 124 into the icon 123 will be discussed. Linkup information concerning the scan and upload function which has not been integrated is that shown in FIG. 5D, and linkup information concerning the scan and box-storage function which has not been integrated is that shown in FIG. 5C.

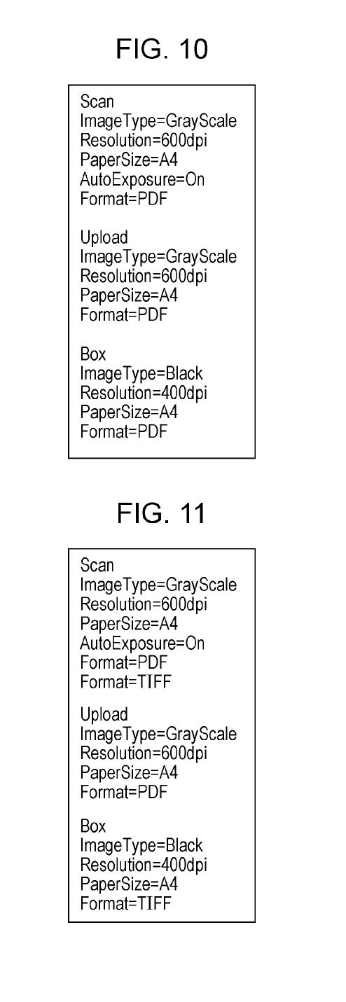

FIG. 10 illustrates linkup-information integrating information. In this example, parameter values for Scan, which is a common function, are set as follows in accordance with the order of priority shown in FIG. 6: ImageType=GrayScale, Resolution=600 dpi, PaperSize=A4, and AutoExposure=On.

Concerning parameter values of non-common functions, PDF is set for Format of Upload, and TIFF is set for Format of Box (see FIGS. 5D and 5C). Since PDF of Upload is a format which has been specified by an upload destination, it is not possible to change. In contrast, as the parameter value of Format of Box, one of BMP, PDF, TIFF, and JPEG may be selected. Accordingly, the controller 4 changes Format of Box to PDF, which is the same format as the format of Upload.

The controller 4 generates an icon associated with a scan-and-upload-and-box-storage function, and stores the generated icon and the linkup-information integrating information in the storage device 5 in association with each other.

When a user places a document on a document table and taps this icon, a screen for inputting or selecting an upload destination is displayed. When the user inputs or selects an upload destination and presses the start key of the keypad 150, processing is started in accordance with the linkup-information integrating information shown in FIG. 10. More specifically, a document is first read by the reader 2 by using the scan function, and image data based on the parameter values, such as ImageType=GrayScale, Resolution=600 dpi, PaperSize=A4, AutoExposure=On, and Format=PDF, is generated. Then, by using the upload function, a copy of the image data is generated, and the copied image data is uploaded to the destination server. Then, by using the box-storage function, a screen for inputting a box number and a password is displayed. When the user inputs a box number and a password and presses the start key, ImageType of the original image data is converted from GrayScale to Black and Resolution of the original image data is converted from 600 dpi to 400 dpi. Then, the converted image data is stored in the storage device 5 in association with the box number.

### Third Exemplary Embodiment

In a third exemplary embodiment, portions different from those of the second exemplary embodiment will be described below.

In the third exemplary embodiment, if a parameter value of a common function is determined while being dependent on some parameter values of non-common functions and if none of such parameter values of the non-common functions are allowed to be changed, the setting section 204 sets such parameter values of the non-common functions as parameter values of the common function.

In the third exemplary embodiment, the scan and upload function is integrated with the scan and box-storage function, as in the second exemplary embodiment. In the third exemplary embodiment, however, neither of the format of the upload function nor the format of the box-storage function is allowed to be changed.

Linkup information concerning the scan and upload function which has not been integrated is that shown in FIG. 5D, and linkup information concerning the scan and box-storage function which has not been integrated is that shown in FIG. 5C.

FIG. 11 illustrates linkup-information integrating information. In this example, as in the example of the second exemplary embodiment, parameter values for Scan, which is a common function, are set as follows in accordance with the order of priority shown in FIG. 6: ImageType=GrayScale, Resolution=600 dpi, PaperSize=A4, and AutoExposure=On.

Concerning parameter values of non-common functions, PDF is set for Format of Upload, and TIFF is set for Format of Box (see FIGS. 5D and 5C). As in the second exemplary embodiment, since PDF of Upload is a format which has been specified by an upload destination, it is not possible to change. In contrast, unlike the second exemplary embodiment, only TIFF is allowed as the parameter value of Format of Box. That is, neither of the parameter values of Format of Upload and Format of Box is possible to change. Accordingly, the controller 4 sets both of PDF and TIFF as the parameter values of Format of Scan.

The controller 4 generates an icon associated with a scan and upload and box-storage function, and stores the generated icon and the linkup-information integrating information in the storage device 5 in association with each other.

When a user places a document on a document table and taps this icon, a screen for inputting or selecting an upload destination is displayed. When the user inputs or selects an upload destination and presses the start key of the keypad 150, processing is started in accordance with the linkup-information integrating information shown in FIG. 11. More specifically, a document is first read by the reader 2 by using the scan function, and first image data based on the parameter values, such as ImageType=GrayScale, Resolution=600 dpi, PaperSize=A4, AutoExposure=On, and Format=PDF, and second image data based on the parameter values, such as ImageType=GrayScale, Resolution=600 dpi, PaperSize=A4, AutoExposure=On, and Format=TIFF, are generated. Then, by using the upload function, the first image data is uploaded to the destination server. Then, by using the box-storage function, a screen for inputting a box number and a password is displayed. When the user inputs a box number and a password and presses the start key, the second image data is stored in the storage device 5 in association with the box number.

### Fourth Exemplary Embodiment

In a fourth exemplary embodiment, portions different from those of the first exemplary embodiment will be described below.

In the fourth exemplary embodiment, if a parameter value of a common function is determined while being dependent on a parameter value used in another apparatus of a communication party which communicates with the image forming apparatus 100, the setting section 204 obtains the parameter value of the common function of the communication party apparatus and sets the obtained parameter value as the parameter value of the common function in the image forming apparatus 100.

In the fourth exemplary embodiment, an example in which the scan and print function is integrated with the scan and fax function by dragging and dropping the icon 121 into the icon 122 will be discussed. Linkup information concerning the scan and print function which has not been integrated is that shown in FIG. 5A, and linkup information concerning the scan and fax function which has not been integrated is that shown in FIG. 5B. In the linkup information shown in FIG. 5B, as the parameter value of ImageType of Fax, Color is set. However, a destination fax machine which receives image data may not support full-color images, in which case, even if full-color image data is output to this destination, only black and white image is output. Since the amount of full-color image data is larger than that of black and white image data, it takes more time to send the full-color image data.

In the fourth exemplary embodiment, a parameter value of the fax function is determined after sending a query to a destination fax machine. For example, in ITU-T (International Telecommunication Union Telecommunication Standardization Sector) recommendations T.30, a procedure for establishing called connection between a sender fax machine and a destination fax machine and then sending queries between the sender fax machine and the destination fax machine about the processing capacity concerning image data is described. In the fourth exemplary embodiment, this protocol is utilized. More specifically, when an integrating operation for integrating the scan and print function with the scan and fax function is performed, the controller 4 establishes called connection with a destination fax machine and queries the destination fax machine as to the parameter value of ImageType of the fax function, and then sets the obtained parameter value of ImageType as the parameter value of the common function.

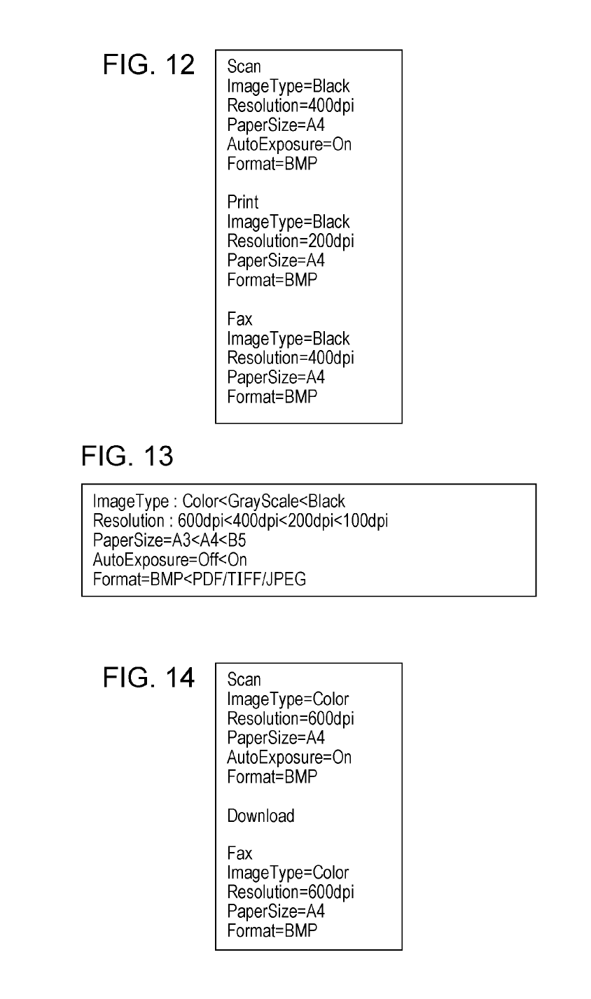

FIG. 12 illustrates linkup-information integrating information. In this example, parameter values of the functions are set as follows in accordance with parameter values of a destination fax machine: ImageType=Black, Resolution=400 dpi, PaperSize=A4, and Format=BMP. That is, Black, which is the same parameter value of the destination fax machine, is set as the parameter value of ImageType of Fax. Additionally, ImageType of Scan is dependent on ImageType of Fax, and thus, Black is set as the parameter value of ImageType of Scan. Black is also set as ImageType of Print.

The controller 4 generates an icon associated with a scan-and-print-and-fax function, and stores the generated icon and the linkup-information integrating information in the storage device 5 in association with each other.

When a user places a document on a document table and taps this icon, a screen for inputting or selecting a fax destination is displayed. When the user inputs or selects a fax destination and presses the start key of the keypad 150, processing is started in accordance with the linkup-information integrating information shown in FIG. 12. More specifically, a document is first read by the reader 2 by using the scan function, and image data based on the parameter values, such as ImageType=Black, Resolution=400 dpi, PaperSize=A4, AutoExposure=On, and Format=BMP, is generated. Then, by using the print function, the image data is copied, and after Resolution of the copied image data is converted from 400 dpi to 200 dpi, an image is formed on a sheet on the basis of the converted image data. Then, by using the fax function, the original image data is sent to the destination fax machine.

### Modified Examples

The above-described exemplary embodiments may be modified as in the following modified examples. The above-described exemplary embodiments may be combined with a modified example, and the plural modified examples may be combined.

### First Modified Example

The order of priority for parameter values may be set such that a higher priority is given to a parameter value, by the use of which image information becomes smaller. In a first modified example, the order of priority for parameter values is determined in accordance with the amount of image information.

FIG. 13 illustrates the order of priority set for parameter values. In this example, the order of priority set for each of ImageType, Resolution, and PaperSize is opposite to that shown in FIG. 6. For example, when the icon 121 (scan and print function) is dragged and dropped into the icon 122 (scan and fax function), the common function is the scan function. The parameter value of Resolution of the scan function associated with the icon 121 is 200 dpi, and that of the icon 122 is 400 dpi. In this case, since 200 dpi has a higher priority than 400 dpi, 200 dpi is set as the parameter value of Resolution of the scan function. That is, when the above-described order of priority is used, the amount of image data becomes smaller than that when the order of priority shown in FIG. 6 is used.

Additionally, a case in which the image forming apparatus 100 is operated in one of a standard mode and a power-saving mode will be considered. In the power-saving mode, less power is consumed than in the standard mode. In this case, if the standard mode is selected, parameter values may be set by utilizing the order of priority shown in FIG. 6, and if the power-saving mode is selected, parameter values may be set by utilizing the order of priority shown in FIG. 13.

### Second Modified Example

In a second modified example, an example in which the scan and fax function is integrated with the download and fax function by dragging and dropping the icon 122 into the icon 125 will be discussed. Linkup information concerning the scan and fax function which has not been integrated is that shown in FIG. 5B, and linkup information concerning the download and fax function which has not been integrated is that shown in FIG. 5E.

FIG. 14 illustrates linkup-information integrating information. In this example, parameter values for Fax, which is a common function, are set as follows in accordance with the order of priority shown in FIG. 6: ImageType=Color, Resolution=600 dpi, PaperSize=A4, and Format=BMP.

Then, concerning the parameter values of a non-common function, the parameter values of Scan are determined while being dependent on the parameter values of Fax. Thus, Resolution of Scan is converted from 400 dpi to 600 dpi.

The controller 4 generates an icon associated with a scan-and-download-and-fax function, and stores the generated icon and the linkup-information integrating information in the storage device 5 in association with each other.

When a user places a document on a document table and taps this icon, a screen for specifying image data to be downloaded is displayed. When the user specifies image data and presses the start key of the keypad 150, processing is started in accordance with the linkup-information integrating information shown in FIG. 14. More specifically, a document is first read by the reader 2 by using the scan function, and first image data based on the parameter values, such as ImageType=Color, Resolution=600 dpi, PaperSize=A4, AutoExposure=On, and Format=PDF, is generated. Then, by using the download function, the specified image data is downloaded. Then, the downloaded image data is converted into second image data having the same parameters as those of the scan function, and the first image data and the second image data are integrated. Then, by using the fax function, a screen for specifying a destination fax machine is displayed. When a user specifies a destination fax machine and presses the start key, the integrated image data is sent to the destination fax machine.

### Third Modified Example

In the above-described exemplary embodiments, an integrating operation is implemented by a drag-and-drop operation performed on icons. However, the integrating operation may be implemented by another operation. For example, a list of function names of individual items of linkup information may be displayed on the touch panel 110, and a user may tap columns of items of linkup information to be integrated.

In the above-described exemplary embodiments, two items of linkup information are integrated. However, three or more items of linkup information may be integrated.

### Fourth Modified Example

In the above-described exemplary embodiments, as an example of an electronic apparatus according to an exemplary embodiment of the invention, an electrophotographic image forming apparatus has been discussed. However, any type of electronic apparatus may be utilized. For example, the electronic apparatus may be an ink-jet image forming apparatus or an image forming apparatus without a scanner function or a fax function. Alternatively, the electronic apparatus may be an information processing apparatus, such as a personal computer.

In the above-described exemplary embodiments, an example in which the control device having the functional configuration shown in FIG. 3 is integrated with the image forming apparatus has been discussed. However, the control device may be configured as a device separate from the image forming apparatus, and may control the image forming apparatus via a communication medium.

In the above-described exemplary embodiments, the controller 4 operates the image forming apparatus 100 by executing a program. This program may be recorded on a computer readable recording medium, such as an optical recording medium or a semiconductor memory, and may be provided, and the program may be read from this recording medium and stored in the storage device 5. The program may be provided via a telecommunications line. Alternatively, functions similar to those of the above-described exemplary embodiments may be implemented by using hardware.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A control device for an electronic apparatus, comprising:
a memory that stores therein linkup information and image data which indicates an operator unique to the linkup information in association with each other, the linkup information indicating a plurality of functions of the electronic apparatus, a linking order of the plurality of functions, and parameter values which are individually set for the plurality of functions and are used when processing is executed by using the plurality of functions in the linking order;
a receiver that displays an image corresponding to the image data indicating the operator stored in the memory and also receives an operation performed on the operator;
an extracting unit that extracts, when an integrating operation for integrating a plurality of items of the linkup information has been received by the receiver, a common function included in all the plurality of items of linkup information; and
a setting unit that sets a parameter value of the common function in accordance with predetermined rules if a parameter value of the common function of one of the plurality of items of linkup information extracted by the extracting unit is different from a parameter value of the common function of another one of the plurality of items of linkup information,
wherein the memory stores therein linkup-information integrating information which indicates an integrating order of the common function and non-common functions, the parameter value of the common function set by the setting unit, and parameter values of the non-common functions, the non-common functions being included in the plurality of items of linkup information to be integrated by the integrating operation and being other than the common function.

2. The control device according to claim 1, wherein the setting unit preferentially selects a parameter value, by the use of which a larger storage area is necessary to execute the processing, and sets the selected parameter value as the parameter value of the common function.

3. The control device according to claim 1, wherein, if a parameter value of the common function is determined while being dependent on one of the parameter values of the non-common functions and if the parameter value of the non-common function which determines the parameter value of the common function is not allowed to be changed, the setting unit sets the parameter value of the non-common function as the parameter value of the common function.

4. The control device according to claim 1, wherein, if a parameter value of the common function is determined while being dependent on some of the parameter values of the non-common functions and if none of the parameter values of the non-common functions which determine the parameter value of the common function are allowed to be changed, the setting unit sets all the parameter values of the non-common functions which determine the parameter value of the common function as parameter values of the common function.

5. The control device according to claim 1, wherein, if a parameter value of the common function is determined while being dependent on a parameter value of the common function used in another apparatus of a communication party which communicates with the electronic apparatus, the setting unit obtains the parameter value of the common function used in the apparatus of the communication party and sets the obtained parameter value as the parameter value of the common function.

6. An electronic apparatus, comprising:
a memory that stores therein linkup information and image data which indicates an operator unique to the linkup information in association with each other, the linkup information indicating a plurality of functions of the electronic apparatus, a linking order of the plurality of functions, and parameter values which are individually set for the plurality of functions and are used when processing is executed by using the plurality of functions in the linking order;
a receiver that displays an image corresponding to the image data indicating the operator stored in the memory and also receives an operation performed on the operator;
an extracting unit that extracts, when an integrating operation for integrating a plurality of items of the linkup information has been received by the receiver, a common function included in all the plurality of items of linkup information; and
a setting unit that sets a parameter value of the common function in accordance with predetermined rules if a parameter value of the common function of one of the plurality of items of linkup information extracted by the extracting unit is different from a parameter value of the common function of another one of the plurality of items of linkup information,
wherein the memory stores therein linkup-information integrating information which indicates an integrating order of the common function and non-common functions, the parameter value of the common function set by the setting unit, and parameter values of the non-common functions, the non-common functions being included in the plurality of items of linkup information to be integrated by the integrating operation and being other than the common function.

7. A control method for an electronic apparatus, comprising:
storing linkup information and image data which indicates an operator unique to the linkup information in association with each other, the linkup information indicating a plurality of functions of the electronic apparatus, a linking order of the plurality functions, and parameter values which are individually set for the plurality of functions and are used when processing is executed by using the plurality of functions in the linking order;
displaying an image corresponding to the stored image data indicating the operator and also receiving an operation performed on the operator;
extracting, when an integrating operation for integrating a plurality of items of the linkup information has been received, a common function included in all the plurality of items of linkup information;
setting a parameter value of the common function in accordance with predetermined rules if a parameter value of the extracted common function of one of the plurality of items of linkup information is different from a parameter value of the extracted common function of another one of the plurality of items of linkup information; and
storing linkup-information integrating information which indicates an integrating order of the common function and non-common functions, the set parameter value of the common function, and parameter values of the non-common functions, the non-common functions being included in the plurality of items of linkup information to be integrated by the integrating operation and being other than the common function.

8. A non-transitory computer readable medium storing a program causing a computer to execute a process for controlling an electronic apparatus, the process comprising:
storing linkup information and image data which indicates an operator unique to the linkup information in association with each other, the linkup information indicating a plurality of functions of the electronic apparatus, a linking order of the plurality functions, and parameter values which are individually set for the plurality of functions and are used when processing is executed by using the plurality of functions in the linking order;
displaying an image corresponding to the stored image data indicating the operator and also receiving an operation performed on the operator;
extracting, when an integrating operation for integrating a plurality of items of the linkup information has been received, a common function included in all the plurality of items of linkup information;
setting a parameter value of the common function in accordance with predetermined rules if a parameter value of the extracted common function of one of the plurality of items of linkup information is different from a parameter value of the extracted common function of another one of the plurality of items of linkup information; and
storing linkup-information integrating information which indicates an integrating order of the common function and non-common functions, the set parameter value of the common function, and parameter values of the non-common functions, the non-common functions being included in the plurality of items of linkup information to be integrated by the integrating operation and being other than the common function.
